(19) United States
(12) Patent Application Publication
(10) Pub. No.: US 2016/0098785 A1
(43) Pub. Date: Apr. 7, 2016

(54) USER EQUIPMENT, CONTROL METHOD THEREOF AND NON-TRANSITORY COMPUTER READABLE STORAGE MEDIUM HAVING COMPUTER PROGRAM RECORDED THEREON

(71) Applicant: SK Planet Co., Ltd., Seongnam-si (KR)

(72) Inventors: Min Kyo SHIN, Seoul (KR); Cheol Su KIM, Seoul (KR); Hwa Yeon LEE, Seoul (KR); Hee Jeong KIM, Seoul (KR)

(21) Appl. No.: 14/834,184

(22) Filed: Aug. 24, 2015

(30) Foreign Application Priority Data
Oct. 2, 2014 (KR) 10-2014-0133423

(51) Int. Cl. G06Q 30/06; G06Q 50/00

(52) U.S. Cl. CPC G06Q 30/0643; G06Q 50/01

(57) ABSTRACT

The present invention provides user equipment, a method of controlling the user equipment, and a non-transitory computer readable storage medium having a computer program recorded thereon. That is, according to the present invention, it is possible to provide an object for posting on SNS by connecting various data and contents accumulated in the entire process of purchases by a customer with the data on a receipt and then can automatically synchronize and display the object on SNS, a blog, or the like, so convenience for users can be improved.

### CROSS-REFERENCE TO RELATED APPLICATION

This application claims the benefit of Korean Application No. 10-2014-0133423 filed on Oct. 2, 2014 with the Korean Intellectual Property Office, the disclosure of which is incorporated herein by reference.

### BACKGROUND OF THE INVENTION

1. Field of the Invention

The present invention relates to user equipment, a control method thereof, and a non-transitory computer readable storage medium having computer program recorded thereon, particularly, user equipment that can simply provide an object for posting on SNS (Social Network Service), using a receipt, a picture, and a message that a consumer receives when purchasing a product, a control method thereof, and a non-transitory computer readable storage medium having computer program recorded thereon.

2. Description of the Related Art

There is provided a service that digitalizes a paper receipt issued to a customer after dealing with a product or a service (that converts a paper receipt into a digitalized type such as an image or a text and then transmits it using an email or SMS (Short Message Service)/LMS (Long Message Service) through a smartphone).

Further, a service that transmits information about payment for a product or a service using a credit card in real time to a customer's smartphone has been popularized and naturally used in everyday life.

Meanwhile, there were a service that keeps, manages, and shares data in a receipt, which is issued to a customer after he/she purchases a product or a service, in combination with other services such as a diary, a housekeeping book, a car management note, and a blog and a service that shows a consumption pattern by displaying information about positions where a credit card is used on a map. These services simply reconstruct or rearrange and then show the purchase data of customers, so it was necessarily limited to use data relating to receipts.

That is, it was difficult to a new type of useful value by recombining and re-compounding various data and contents about purchases. Further, users have to searches every relevant information in order to find or use purchase details and additional relevant information, so it take a lot of time and effort to access and use information.

### PRIOR ART DOCUMENT

### Patent Document

Korean Patent Publication No. 10-2012-0001089 [Title: System for managing expenditure record by internet]

### SUMMARY OF THE INVENTION

An object of the present invention is to provide user equipment that can provide an object for posting on SNS by connecting various data and contents accumulated in the entire process of purchases by a customer with the data on a receipt and then can automatically synchronize and display the object on SNS, a blog, or the like.

Further, another object of the present invention is to provide user equipment that allows a user to continuously secure useful information contents about interested fields of customers in connection with the details and activities of purchasing products or services.

User equipment according to an embodiment of the present invention may include: a receipt data acquiring unit that acquires receipt data including payment product information, time information, and place information; a product image acquiring unit that acquires a product image connected with payment product information in the receipt data; a picture data acquiring unit that acquires relevant picture data connected with the receipt data in picture data in a storage unit on the basis of the receipt data; a message data acquiring unit that acquires relevant message data connected with time information in the receipt data in message data kept in the storage unit on the basis of the receipt data; and an object creating unit that creates an object for posting on a social network on the basis of the product image, the relevant picture data, and the relevant message data.

As an example of the present invention, the user equipment may further include a communication unit that transmits the object for posting on a social network to a social network service providing device.

As an example of the present invention, the picture data acquiring unit may compare at least one of the time information and the place information in the receipt data with at least one of the time information and the place information in the picture data and acquire relevant picture data connected with the receipt data on the basis of the comparing result.

As an example of the present invention, the message data acquiring unit may compare the time information in the receipt data and the time information in the message data and acquire relevant message data connected with the receipt data on the basis of the comparing result.

As an example of the present invention, the user equipment may further include: a display unit that displays the object for posting on a social network; and a user input unit that acquires user input about the object for posting on a social network.

As an example of the present invention, the object creating unit may change the object for posting on a social network on the basis of user input.

A method of controlling user equipment according to an embodiment of the present invention may include: acquiring receipt data including payment product information, time information, and place information by means of a receipt data acquiring unit; acquiring a product image connected with payment product information in the receipt data by means of a product image acquiring unit; acquiring relevant picture data connected with the receipt data in picture data in a storage unit on the basis of the receipt data by means of a picture data acquiring unit; acquiring relevant message data connected with time information in the receipt data in message data kept in the storage unit on the basis of the receipt data by means of a message data acquiring unit; and creating an object for posting on a social network on the basis of the product image, the relevant picture data, and the relevant message data by means of an object creating unit.

As an example of the present invention, the method may further include: classifying a plurality of objects for posting on a social network into categories by means of a category classifying unit; and acquiring customer concern field information based on the classifying result by means of the category classifying unit.

As an example of the present invention, the method may further include: requesting a service providing device to transmit data connected with the customer concern field information by means of a communication unit; and receiving data connected with the user concern field information from the service providing device by means of the communication unit.

According to another aspect of the present invention, a computer program comprising a set of instructions, when executed, arranged to cause a computer to perform the method of controlling user equipment may be kept in a non-transitory computer readable storage medium.

According to the present invention, it is possible to provide user equipment that can provide an object for posting on SNS by connecting various data and contents accumulated in the entire process of purchases by a customer with the data on a receipt and then can automatically synchronize and display the object on SNS, a blog, or the like.

Further, according to the present invention, it is possible to provide user equipment that allows a user to continuously secure useful information contents about interested field of a customer in connection with the details and activities of purchasing products or services.

### BRIEF DESCRIPTION OF THE DRAWINGS

FIG. 1 is a diagram illustrating a social network system according to an embodiment of the present invention.

FIG. 2 is a block diagram illustrating user equipment according to an embodiment of the present invention.

FIG. 3 is an example of a digitalized receipt displayed on a display unit of user equipment.

FIG. 4 is an example of a product image acquired by a product image acquiring unit.

FIGS. 5A and 5B are diagrams illustrating an example of a plurality of picture data kept in a storage unit.

FIG. 6 is a diagram illustrating an example of a plurality of message data kept in a storage unit.

FIG. 7 is an example of an object for posting on a social network created by an object creating unit 150.

FIG. 8 is an example of an object for acquiring user input about an object for posting on a social network.

FIG. 9 is a diagram illustrating a plurality of objects for posting on a social network classified into categories.

FIG. 10 is a diagram illustrating a process of requesting transmission of data connected with customer concern field information.

### DETAILED DESCRIPTION OF THE PREFERRED EMBODIMENTS

It should be noted that technical terminologies used herein are used only in order to describe specific embodiments rather than limiting the present invention. Further, the technical terminologies used here should be construed as being generally understood by those skilled in the art unless defined as specific meanings, not construed as being excessively general meanings or excessively narrow meanings. Further, if the technical terminologies used herein are wrong technical terminologies that cannot exactly express the spirit of the present invention, they should be replaced by technical terminologies that can be correctly understood by those skilled in the art. Further, common terms used herein should be construed in accordance with dictionary definitions or contexts, not being as excessively narrow meanings.

The singular forms used herein are intended to include the plural forms as well, unless the context clearly indicates otherwise. Terms “composed of” or “include” used herein should not construed as necessarily including all of various components or various steps, but construed that they may not include some of the components or steps or may further include additional components or steps.

Further, terms including ordinal numbers such as ‘first’ and ‘second’ may be used to describe various components, but the components are not to be construed as being limited to the terms. The terms are used to distinguish one component from another component. For example, the ‘first’ component may be named the ‘second’ component, and vice versa, without departing from the scope of the present invention.

Hereinafter, embodiments of the present invention will be described in detail with reference to the accompanying drawings, like reference numerals are given to like or similar components regardless of the figure numbers, and repeated description is not provided.

Further, in describing the present invention, detailed descriptions of well-known technologies will be omitted so as not to obscure the description of the present invention with unnecessary detail. Further, it should be noted that the accompanying drawings are provided only for easier understanding of the spirit of the present invention and should not be construed as limiting the spirit of the present invention.

The user equipment described herein is a general term including all kinds of terminals receiving orders from a user and performing selected work, such as a tablet PC, a notebook, and a desktop, including hand-held type terminals such as a mobile communication terminal.

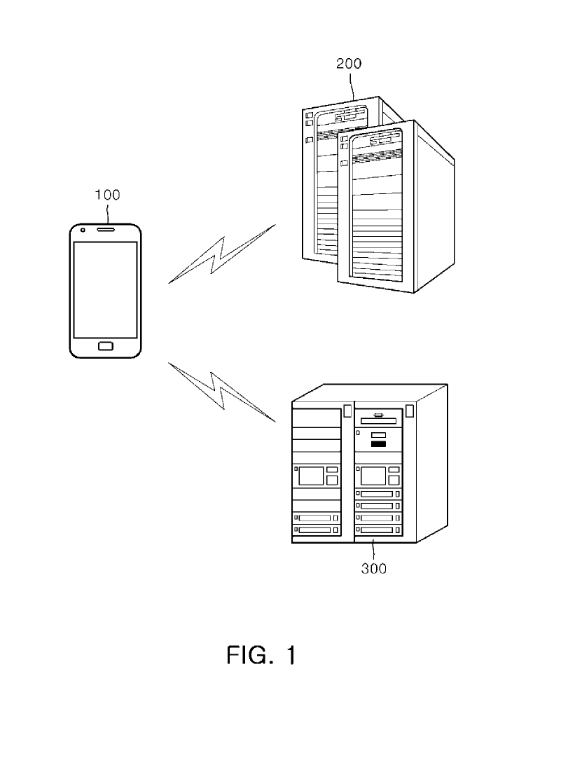

FIG. 1 is a diagram illustrating a social network system according to an embodiment of the present invention.

As illustrated in FIG. 1, a social network system according to an embodiment of the present invention may include user equipment 100, a receipt information service providing device 200, and a social network service providing device 300.

Herein, the receipt information service providing device 200 may provide a digital receipt to the user equipment 100.

In this case, the digital receipt may include payment product information (such as, product name and product code), payment time information, and payment place information.

The user equipment 100 can acquire corresponding product image information on the basis of payment product information on a digital receipt. Further, the user equipment 100 can acquire picture data and message data associated with a digital receipt on the basis of payment time information and payment place information on the digital receipt. For example, the acquired picture data may be a picture taken in a store. Further, the acquired message data may be message sent/received by a user in transaction.

The user equipment 100 can create an object for posting on a social network on the basis of product image information, acquired picture data, and acquired message data.

Herein, the object for posting on a social network means an object in a type suitable for uploading on a social network service providing device and may be formed by combining a text message, an image, a moving image (video), an icon, a sound, a data file, an email, a posting on a SNS, a memo, and information showing sending or receiving of a call or an instant message.

The social network service providing device 300 can receive and post an object for posting on a social network from the user equipment 100.

According to an embodiment of the present invention, it is possible to integrally record, manage, and share contents about purchases of customers which were distributed and managed on a receipt of purchasing a product or a service, a camera App in a smartphone, and a mobile messenger, reconfigured or rearranged, and partially used in connection with other services.

In detail, according to the present invention, it is possible to selectively package purchase information on a receipt, information about pictures taken by user in purchase, and conversations through a mobile messengers and post them on a social network.

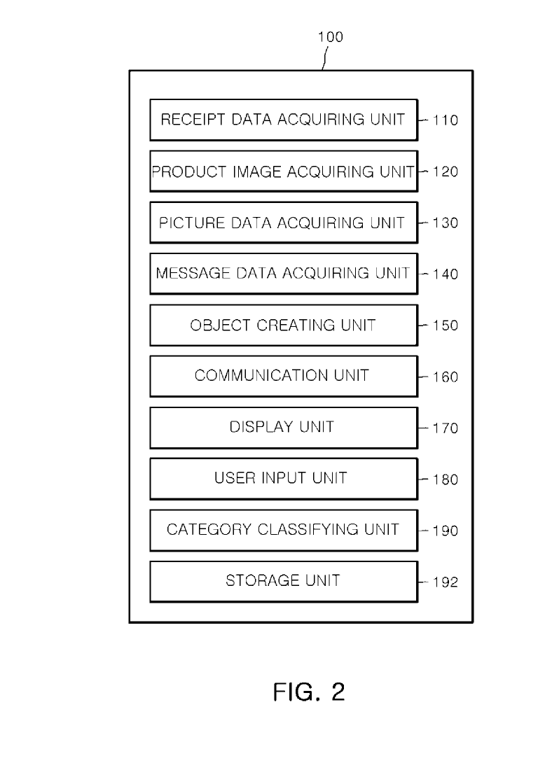

FIG. 2 is a block diagram illustrating user equipment according to an embodiment of the present invention.

As illustrated in FIG. 2, the user equipment 100 may include a receipt data acquiring unit 110, a product image acquiring unit 120, a picture data acquiring unit 130, a message data acquiring unit 140, an object creating unit 150, a communication unit 160, a display unit 170, a user input unit 180, a category classifying unit 190, and a storage unit 192. The user equipment 100 may be composed of components more than them in FIG. 2 or composed of components less than them.

The receipt data acquiring unit 100 can acquire receipt data including payment product information (for example, product name and product code), payment time information, and payment place information. For example, the receipt data acquiring unit 100 may receive receipt data from a receipt information service providing device.

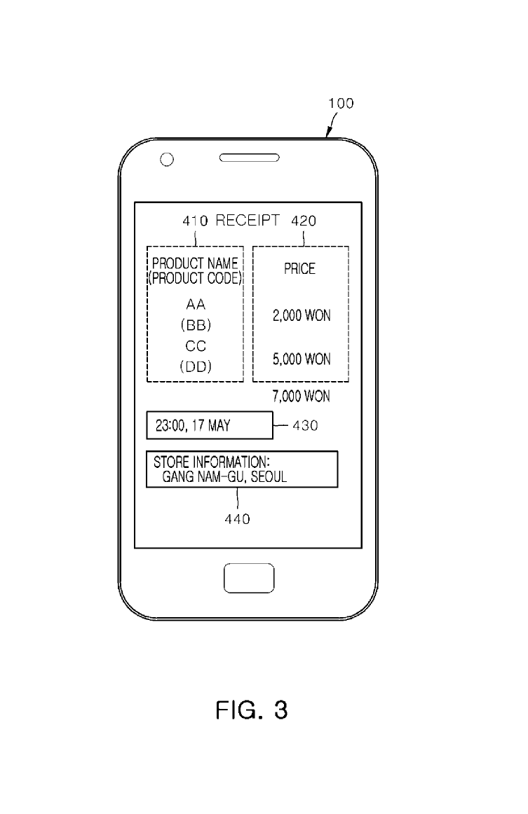

FIG. 3 is an example of a digitalized receipt display on a display unit of user equipment.

As illustrated in FIG. 3, receipt data may include information about a purchased product name 410, a product price 420, a payment time 430, and a payment place 440.

Meanwhile, the product image acquiring unit 120 can acquire an image associated with payment product information in receipt data. For example, the product image acquiring unit 120 can receive an image of payment product information in receipt data through a communication network.

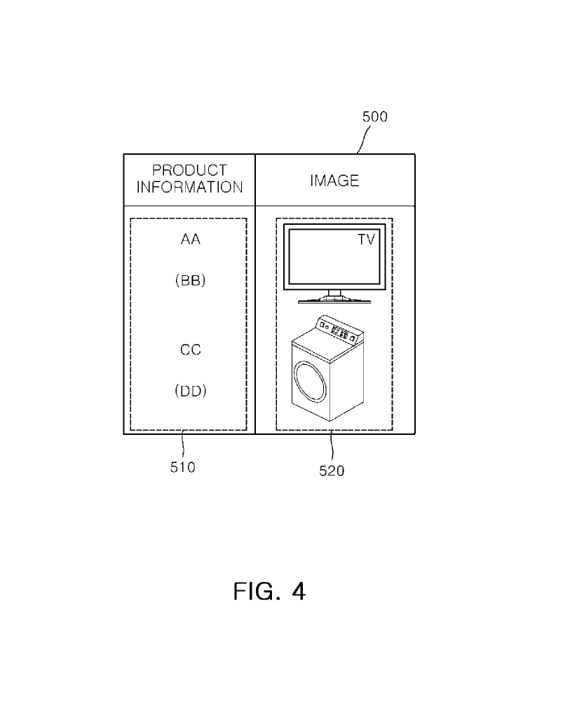

FIG. 4 is an example of a product image acquired by a product image acquiring unit.

That is, the product image acquiring unit can receive an image 520 corresponding to the payment product information 510 illustrated in FIG. 3 through a communication network.

Since the user equipment can acquire an image corresponding to payment product information by the product image acquiring unit, the user can easily take information about the purchased product even without separately searching images about the product.

Meanwhile, the picture data acquiring unit can acquire relevant picture data associated with receipt data from picture data in the storage unit 192 on the basis of the receipt data.

The user equipment according to an embodiment of the present invention can store a plurality of picture data in the storage unit 192.

It is required to acquire an image associated with receipt data in order to create an object for posting on social network. The picture data acquiring unit can acquire an image associated with receipt data.

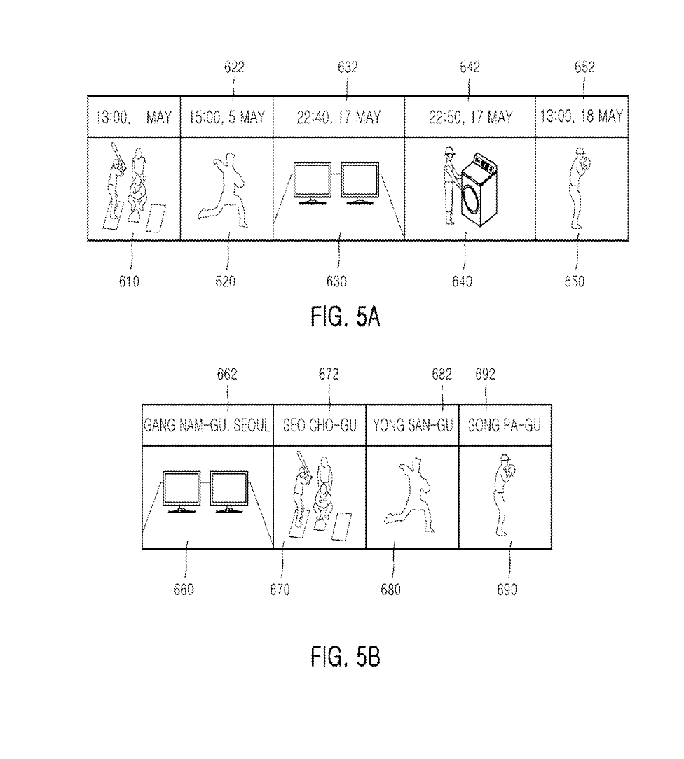

FIGS. 5A and 5B are diagrams illustrating an example of a plurality of picture data kept in a storage unit.

FIG. 5A illustrates a plurality of picture data 620 to 650 classified into photographing times and FIG. 5B illustrates a plurality of picture data 660 to 690 classified into photographing places.

As illustrated in FIGS. 5A and 5B, the picture data may include time information 622, 632, 642, and 652, place information 662, 672, 682, and 692. The place information may be displayed as GPS information.

The picture data acquiring unit can compare at least one of the time information 430 and the place information 440 in receipt data with at least one of the time information 622, 632, 642, and 652 and the place information 662, 672, 682, and 692 in the picture data and acquire relevant picture data connected with the receipt data on the basis of the comparing result.

For example, the picture data acquiring unit may compare the time information 430 in receipt data with time information 622, 632, 642, and 652 in picture data and acquire picture data, in which the difference between its time information and time information in the receipt data is within a predetermined range, as relevant picture data.

The picture data 630 and 640 may be relevant picture data in FIG. 5A.

Further, the picture data acquiring unit may compare the place information 440 in receipt data with place information 662, 672, 682, and 692 in picture data acquire picture data, in which the difference between its place information and place information in the receipt data is within a predetermined range, as relevant picture data.

The picture data 662 may be relevant picture data in FIG. 5B.

Meanwhile, the message data acquiring unit 140 can acquire relevant message data associated with the receipt data in message data kept in the storage unit on the basis of the receipt data.

The user equipment according to an embodiment of the present invention can keep a plurality of message data in the storage unit.

It is required to acquire a relevant message associated with receipt data in order to create an object for posting on social network. In this case, the message data acquiring unit can acquire a relevant message associated with receipt data.

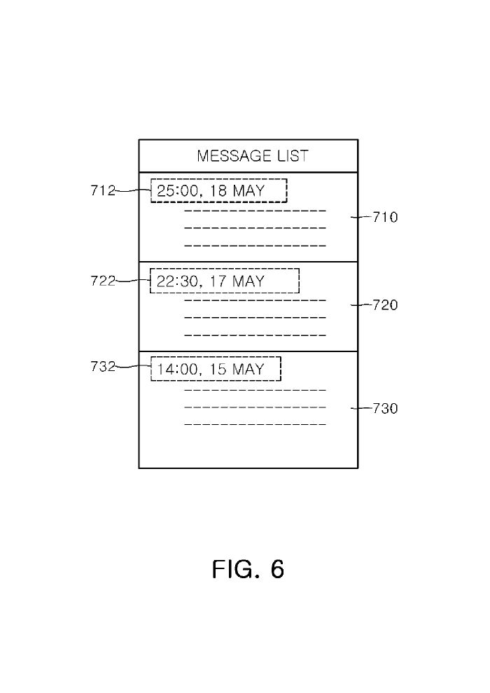

FIG. 6 is a diagram illustrating an example of a plurality of message data kept in a storage unit.

As illustrated in FIG. 6, message data 710, 720, and 730 may include time information 712, 722, and 732, respectively.

The message data acquiring unit can compare the time information 430 in receipt data and time information 712, 722, and 723 in message data and acquire relevant message data associated with receipt data on the basis of the comparing result.

For example, the message data acquiring unit may compare the time information 430 in receipt data with time information 712, 722, and 732 in picture data and acquire message data, in which the difference between its time information and time information in the receipt data is within a predetermined range, as relevant message data.

Meanwhile, the object creating unit 150 can create an object for posting on a social network on the basis of a product image acquired by the product image acquiring unit 120, relevant picture data acquired by the picture data acquiring unit 130, and relevant message data acquired by the message data acquiring unit 140.

Meanwhile, the display unit 170 can display an object for posting on a social network created by the object creating unit 150.

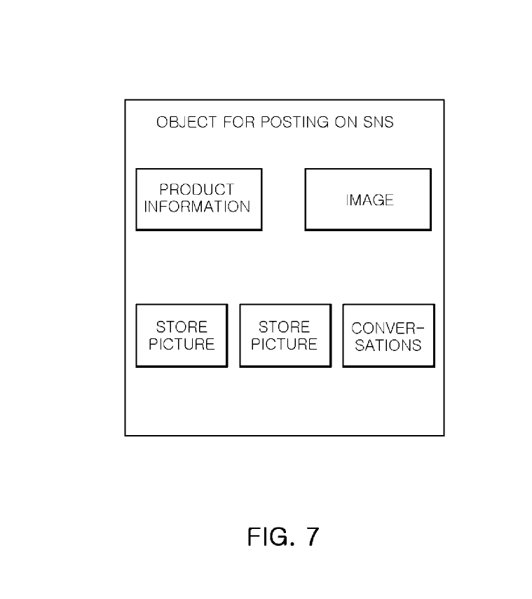

FIG. 7 is an example of an object for posting on a social network created by an object creating unit 150.

As illustrated in FIG. 7, an object for posting on a social network may include product information, a product image, relevant picture data, and relevant message data.

Meanwhile, the user input unit 180 can acquire user input about an object for posting on a social network created by the object creating unit 150.

In this case, the object creating unit 150 can change the object for posting on a social network on the basis of the user input.

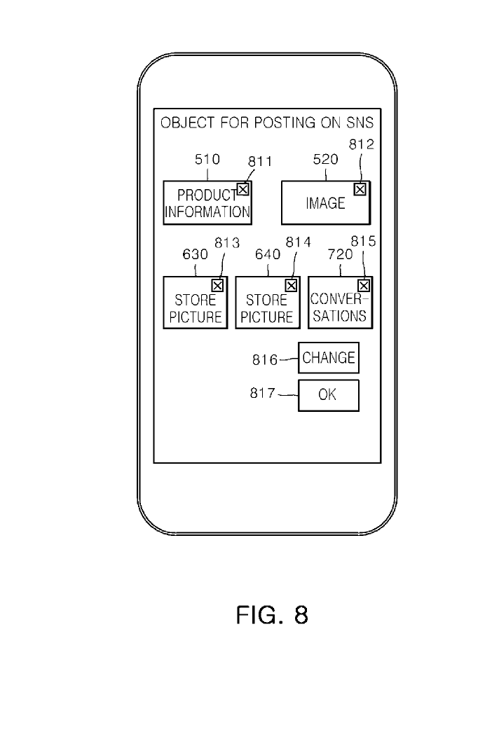

FIG. 8 is an example of an object for acquiring user input about an object for posting on a social network.

As illustrated in FIG. 8, user equipment can display objects 811, 812, 813, 814, and 815 for deleting components in an object for posting on a social network created by the object creating unit 150, an object 816 for changing the components, and an object 817 for deciding the components. Further, the user equipment can change an object for posting on a social network on the basis of user input about objects 811 to 817.

Meanwhile, the communication unit 160 can transmit an object for posting on a social network created by the object creating unit 150 to a social network service providing device.

According to the present invention, it is possible to provide user equipment that can provide an object for posting on SNS by connecting various data and contents accumulated in the entire process of purchases by a customer with the data on a receipt and then can automatically synchronize and display the object on SNS, a blog, or the like.

Meanwhile, the category classifying unit 190 can classify a plurality of objects for posting on a social network created by user equipment into categories.

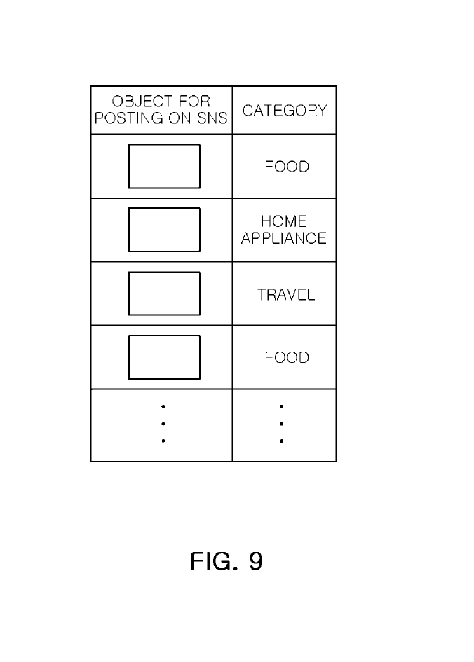

FIG. 9 is a diagram illustrating a plurality of objects for posting on a social network classified into categories.

According to this embodiment, categories that a user is interested in can be found out.

That is, the category classifying unit can acquire customer interest field information based on the result of classifying categories.

Meanwhile, according to an embodiment of the present invention, the communication unit 160 can request a service providing device to transmit data associated with the customer interest field information.

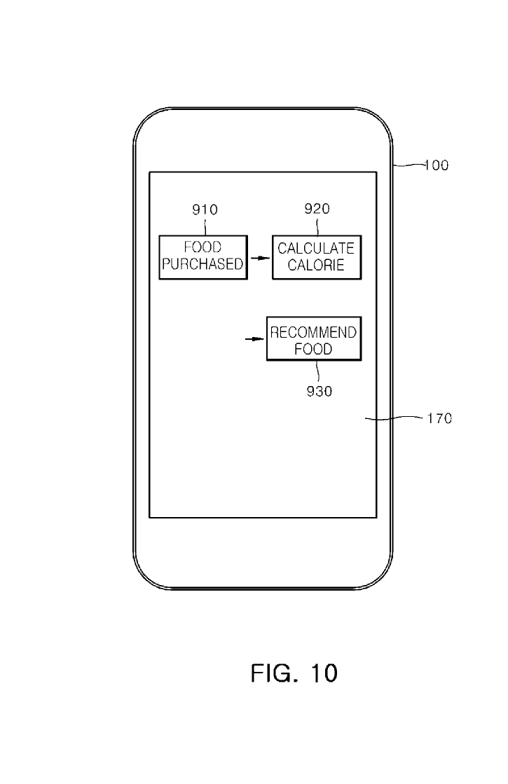

FIG. 10 is a diagram illustrating a process of requesting transmission of data associated with customer interest field information.

As illustrated in FIG. 10, user equipment can display objects 920 and 930 for requesting transmission of data associated with customer interest field information 910.

In this case, on the basis of user input about objects 920 and 930, the communication unit 160 can request a service providing device to transmit data associated with the customer interest field information.

Further, the communication unit 160 can receive data associated with customer interest field information from a service providing device.

According to the present invention, it is possible to provide user equipment that allows a user to continuously secure useful information contents about interested field of a customer in connection with the details and activities of purchasing products or services.

For example, when a user continuously creates objects for posting on a social network about food, which he/she has purchased and taken, the user can check calorie information about the food, which he/she has purchased and taken, and additional information about his/her health (for example, recommendation information about low-calorie food), through user equipment. Further, a customer can check the additional information about health and use it for purchasing food later.

A method of controlling user equipment according to an embodiment of the present invention can be recorded in a computer program, and codes and code segments of the computer program can be easily inferred by computer programmers in the field. The computer program is stored in non-transitory computer readable media, and read and executed by user equipment according to an embodiment of the present invention, so the method of controlling the user equipment can be implemented.

The non-transitory computer readable storage media include a magnetic recording medium, an optical recording medium, and a carrier wave medium. A computer program for achieving the method of controlling user equipment according to an embodiment of the present invention may be stored and installed in a built-in memory in the user equipment. Alternatively, an external memory such as a smart card in which a computer program for achieving the method of controlling user equipment according to an embodiment of the present invention is stored and installed may be mounted on the user equipment through an interface.

It should be understood that the present invention may be changed and modified by those skilled in the art without departing from the scope of the present invention. Accordingly, the embodiment described herein are provided not to limit, but to explain the spirit of the present invention and the spirit and the scope of the present invention are not limited by the embodiments. The protective range of the present disclosure should be construed on the basis of claims and all the technical spirits in the equivalent range should be construed as being included in the scope of the right of the present disclosure.

According to the present invention, it is possible to provide an object for posting on SNS by connecting various data and contents accumulated in the entire process of purchases by a customer with the data on a receipt and then can automatically synchronize and display the object on SNS, a blog, or the like, so convenience for users can be improved. Therefore, the present invention can be used in various fields including electronic transaction and marketing.

What is claimed is:

1. User equipment comprising:
a receipt data acquiring unit that acquires receipt data including payment product information, time information, and place information;
a product image acquiring unit that acquires a product image associated with the payment product information in the receipt data;
a picture data acquiring unit that acquires relevant picture data associated with the receipt data from picture data in a storage unit on the basis of the receipt data;
a message data acquiring unit that acquires relevant message data associated with the time information in the receipt data from message data stored in the storage unit on the basis of the receipt data; and
an object creating unit that creates an object for posting on a social network on the basis of the product image, the relevant picture data, and the relevant message data.

2. The user equipment of claim 1, further comprising a communication unit that transmits the object for posting on the social network to a social network service providing device.

3. The user equipment of claim 1, wherein the picture data acquiring unit compares at least one of the time information and the place information in the receipt data with at least one of the time information and the place information in the picture data and acquires relevant picture data associated with the receipt data on the basis of the comparing result.

4. The user equipment of claim 1, wherein the message data acquiring unit compares the time information in the receipt data and the time information in the message data and acquires relevant message data associated with the receipt data on the basis of the comparing result.

5. The user equipment of claim 1, further comprising:
a display unit that displays the object for posting on the social network; and
a user input unit that acquires a user input about the object for posting on the social network.

6. The user equipment of claim 5, wherein the object creating unit changes the object for posting on the social network on the basis of the user input.

7. A method of controlling user equipment comprising:
acquiring receipt data including payment product information, time information, and place information by means of a receipt data acquiring unit;
acquiring a product image associated with the payment product information in the receipt data by means of a product image acquiring unit;
acquiring relevant picture data associated with the receipt data from picture data in a storage unit on the basis of the receipt data by means of a picture data acquiring unit;
acquiring relevant message data associated with the time information in the receipt data from message data stored in the storage unit on the basis of the receipt data by means of a message data acquiring unit; and
creating an object for posting on a social network on the basis of the product image, the relevant picture data, and the relevant message data by means of an object creating unit.

8. The method of claim 7, further comprising:
classifying a plurality of objects for posting on the social network into categories by means of a category classifying unit; and
acquiring customer interest field information based on the classifying result by means of the category classifying unit.

9. The method of claim 8, further comprising:
requesting a service providing device to transmit data associated with the customer interest field information by means of a communication unit; and
receiving data associated with the user interest field information from the service providing device by means of the communication unit.

10. A non-transitory computer readable storage medium storing a computer program comprising a set of instructions, when executed, arranged to cause a computer to perform operations comprising:
acquiring receipt data including payment product information, time information, and place information by means of a receipt data acquiring unit;
acquiring a product image associated with the payment product information in the receipt data by means of a product image acquiring unit;
acquiring relevant picture data associated with the receipt data from picture data in a storage unit on the basis of the receipt data by means of a picture data acquiring unit;
acquiring relevant message data associated with the time information in the receipt data from message data stored in the storage unit on the basis of the receipt data by means of a message data acquiring unit; and
creating an object for posting on a social network on the basis of the product image, the relevant picture data, and the relevant message data by means of an object creating unit.

11. A non-transitory computer readable storage medium of claim 10, the operations further comprising:
classifying a plurality of objects for posting on the social network into categories by means of a category classifying unit; and
acquiring customer interest field information based on the classifying result by means of the category classifying unit.

12. A non-transitory computer readable storage medium of claim 11, the operations further comprising:
requesting a service providing device to transmit data associated with the customer interest field information by means of a communication unit; and
receiving data associated with the user interest field information from the service providing device by means of the communication unit.
